(19) United States
(12) Patent Application Publication
(10) Pub. No.: US 2013/0070481 A1
(43) Pub. Date: Mar. 21, 2013

(54) LINEAR LIGHT SOURCE APPARATUS

(71) Applicant: Yuhki ITO, Kiyosu-shi (JP)

(72) Inventor: Yuhki ITO, Kiyosu-shi (JP)

(73) Assignee: Toyoda Gosei Co., Ltd., Kiyosu-shi (JP)

(21) Appl. No.: 13/607,238

(22) Filed: Sep. 7, 2012

(30) Foreign Application Priority Data
Sep. 20, 2011 (JP) 2011-205196

(51) Int. Cl. F21V 9/16; F21V 8/00

(52) U.S. Cl. 362/613; 362/84

(57) ABSTRACT

The present invention provides a linear light source apparatus in which warpage is suppressed. The linear light source apparatus includes an elongated rectangular wiring substrate; a plurality of light-emitting devices which are aligned on an imaginary straight line on the wiring substrate; reflectors provided on the wiring substrate such that each reflector corresponds to one light-emitting device; a sealing resin portion which seals each of the light-emitting devices; and a fluorescent material sheet provided on the reflectors. Since the fluorescent material sheet is provided so as to cover the reflectors, stress applied to the wiring substrate, which is caused by thermal shrinkage of the sealing resin portion, can be relaxed, warpage of the linear light source apparatus can be prevented, and color unevenness can be suppressed in light emitted from the linear light source apparatus.

### BACKGROUND OF THE INVENTION

1. Field of the Invention

The present invention relates to a light source apparatus in which a plurality of light-emitting devices are aligned linearly, and which is employed as, for example, a backlight source of a small-sized liquid crystal display panel.

2. Background Art

A light source including a light guide plate and a linear light source apparatus (see, for example, Patent Document 1) provided on a side surface of the light guide plate has been known as a backlight source of the liquid crystal display panel of a cellular phone or a digital camera.

This linear light source apparatus includes an elongated rectangular printed board having a wiring pattern thereon; a plurality of light-emitting devices which are provided on the printed board so as to be separated from one another along a longitudinal direction of the printed board, and which are connected to the wiring pattern of the printed board; reflectors each having an inclined surface and which are provided on the two longitudinal sides of each light-emitting device; and a sealing resin portion which seals each of the light-emitting devices.

When the sealing resin portion of this linear light source apparatus is thermally cured, shrinkage occurs, and the light source apparatus warps so as to be convex downward (i.e., in a direction from the surface of the printed board on which the light-emitting devices are mounted toward the opposite surface of the printed board). Therefore, adhesion between the linear light source apparatus and the light guide plate is lowered, and the performance of light incidence to the light guide plate is reduced.

Patent Document 2 discloses a technique for preventing warpage of such a linear light source apparatus, in which a reflector corresponding to a light-emitting device and a reflector corresponding to another adjacent light-emitting device are discontinuously provided so as to be separated from each other by a groove formed therebetween. This groove relaxes stress caused by shrinkage of the sealing resin portion, and prevents warpage of the light source apparatus.

Patent Document 3 discloses a light source apparatus including a substrate having a wiring pattern thereon; a plurality of light-emitting devices which are provided on the substrate so as to be separated from one another, and which are connected to the wiring pattern; a reflector provided so as to surround each light-emitting device and having inclined surfaces on the sides facing the light-emitting device; and a sealing resin portion which seals each of the light-emitting devices, wherein the sealing resin portion is formed of a transparent resin, and a fluorescent material layer is provided on the sealing resin portion.
Patent Document 1: Japanese Patent Application Laid-Open (kokai) No. 2004-235139
Patent Document 2: Japanese Patent Application Laid-Open (kokai) No. 2006-120691
Patent Document 3: Japanese Patent Application Laid-Open (kokai) No. 2006-100441

However, the technique disclosed in Patent Document 2 may fail to exhibit a sufficient effect of preventing warpage of the light source apparatus. Therefore, there may arise problems in that adhesion between the light source apparatus and a light guide plate is lowered due to warpage of the apparatus; the performance of light incidence to the light guide plate is reduced; and the brightness of a backlight source is lowered.

### SUMMARY OF THE INVENTION

In view of the foregoing, an object of the present invention is to provide a linear light source apparatus in which warpage is more effectively prevented.

In a first aspect of the present invention, there is provided a linear light source apparatus comprising a rectangular wiring substrate having thereon a wiring pattern; a plurality of light-emitting devices which are provided on the wiring substrate so as to align on an imaginary straight line along a longitudinal direction of the wiring substrate, and which are connected to the wiring pattern of the wiring substrate; reflectors each having inclined surfaces on the two longitudinal sides of each light-emitting device, and which are provided separately from one another such that each reflector corresponds to one light-emitting device; a sealing resin portion which seals each light-emitting device, and a fluorescent material sheet provided above all the light-emitting devices so as to cover and to be in contact with the reflectors; wherein the fluorescent material sheet is not in contact with the sealing resin portion above each light-emitting device, by the intervention of an air layer.

The fluorescent material sheet is formed of a sheet-like product formed from, for example, glass, an acrylic resin, an epoxy resin, a modified epoxy resin, a silicone resin, or a modified silicone resin, each of which being mixed with a fluorescent material. The fluorescent material sheet is preferably formed from a material having rigidity greater than that of the wiring substrate, since, in this case, warpage of the linear light source apparatus can be more suppressed. When a surface light source apparatus is produced by bringing the fluorescent material sheet of the linear light source apparatus of the present invention into contact with a side surface of a light guide plate, the fluorescent material sheet is preferably formed from a material having a refractive index lower than that of the material of the light guide plate. This is because, in this case, the performance of light incidence to the light guide plate can be improved.

The emission wavelength of the light-emitting device and the fluorescence wavelength of the fluorescent material incorporated into the fluorescent material sheet may be employed in any combination in consideration of the intended color of light from the linear light source apparatus. For example, when white light is to be emitted from the linear light source apparatus, a Group III nitride semiconductor light-emitting device which emits blue light may be employed in combination with a yellow fluorescent material which is excited by blue light and emits yellow light.

The sealing resin portion is preferably transparent. As used herein, the term “transparent” refers to high transmittance with respect to the emission wavelength of the light-emitting device. When the sealing resin portion is transparent, color unevenness can be suppressed in light emitted from the linear light source apparatus. Preferably, the sealing resin portion is not in contact with the reflectors. When the sealing resin portion is not in contact with the reflectors, stress caused by thermal shrinkage of the sealing resin portion can be reduced, and warpage of the linear light source apparatus can be suppressed.

A second aspect of the present invention is drawn to a specific embodiment of the linear light source apparatus according to the first aspect, wherein the fluorescent material sheet has rigidity greater than that of the wiring substrate.

A third aspect of the present invention is drawn to a specific embodiment of the linear light source apparatus according to the first or second aspect, wherein the sealing resin portion is not in contact with the reflectors.

A fourth aspect of the present invention is drawn to a specific embodiment of the linear light source apparatus according to any of the first to third aspects, wherein the sealing resin portion is formed of a transparent resin.

A fifth aspect of the present invention is drawn to a specific embodiment of the linear light source apparatus according to any of the first to fourth aspects, wherein the fluorescent material sheet is formed of glass, an acrylic resin, an epoxy resin, a modified epoxy resin, a silicone resin, or a modified silicone resin, each of which being mixed with a fluorescent material.

In a sixth aspect of the present invention, there is provided a surface light source apparatus comprising a light guide plate, and a linear light source apparatus as recited in any of the first to fifth aspects, the linear light source apparatus being provided such that an emission surface thereof faces a side surface of the light guide plate, wherein the linear light source apparatus is disposed such that the fluorescent material sheet thereof is in contact with the side surface of the light guide plate, and the fluorescent material sheet has a refractive index equal to or lower than that of the light guide plate.

According to the linear light source apparatus of the present invention, since the fluorescent material sheet is provided so as to cover the reflectors, warpage of the apparatus can be prevented, and color unevenness can be suppressed in light emitted from the apparatus. Also, since the fluorescent material sheet, which is provided above the light-emitting devices, is not in contact with the sealing resin portion, by the intervention of an air layer, when a surface light source apparatus is produced by combining the linear light source apparatus of the present invention with a light guide plate, heat is less likely to be conducted to the light guide plate, and thus the light guide plate can be prevented from being degraded. In addition, since the amount of the sealing resin portion can be reduced as compared with conventional cases, warpage of the linear light source apparatus can be further suppressed.

According to the second aspect of the present invention, warpage of the linear light source apparatus can be suppressed to a greater extent.

According to the third aspect of the present invention, stress caused by thermal shrinkage of the sealing resin portion can be reduced, and thus warpage of the linear light source apparatus can be further suppressed.

According to the fourth aspect of the present invention, color unevenness can be further suppressed in light emitted from the linear light source apparatus.

According to the surface light source apparatus of the present invention, the performance of light incidence to the light guide plate can be further improved.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a cross-sectional view of the configuration of a linear light source apparatus according to Embodiment 1;

FIG. 2 is a perspective view of the configuration of the linear light source apparatus according to Embodiment 1; and

FIG. 3 shows the configuration of a surface light source apparatus according to Embodiment 2.

### DETAILED DESCRIPTION OF PREFERRED EMBODIMENTS

Specific embodiments of the present invention will next be described with reference to the drawings. However, the present invention is not limited to the embodiments.

### Embodiment 1

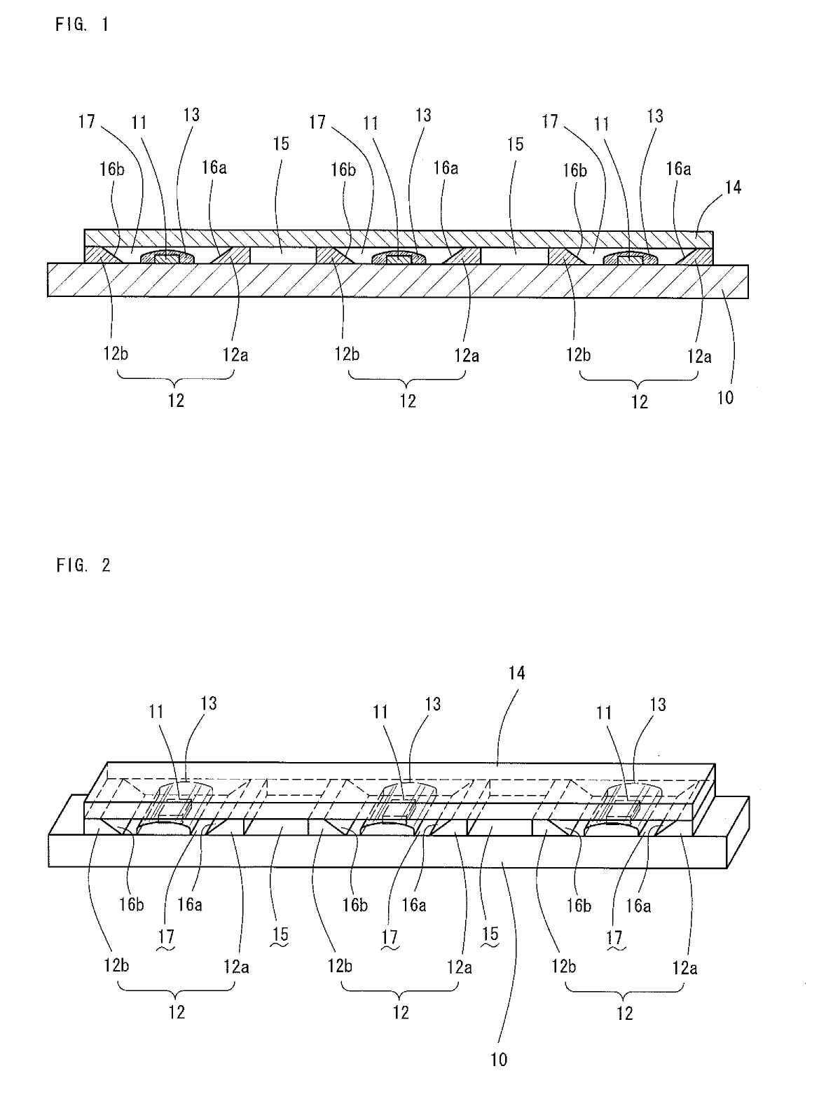

FIG. 1 is a cross-sectional view of the configuration of a linear light source apparatus 1 according to Embodiment 1, and FIG. 2 is a perspective view of the configuration of the linear light source apparatus 1. As shown in FIGS. 1 and 2, the linear light source apparatus 1 according to Embodiment 1 includes an elongated rectangular wiring substrate 10; a plurality of light-emitting devices 11 which are aligned on an imaginary straight line on the wiring substrate 10; reflectors 12 provided on the wiring substrate 10 such that each reflector corresponds to one light-emitting device; a sealing resin portion 13 which seals each of the light-emitting devices 11; and a fluorescent material sheet 14 provided on the reflectors 12.

The wiring substrate 10 is an FR-5 substrate formed from a glass fabric substrate and an epoxy resin. The wiring substrate 10 may be, for example, an FR-4 substrate. The wiring substrate 10 has a wiring pattern on a surface thereof. The wiring pattern is connected to the light-emitting devices 11 by means of bonding wires (not illustrated). The wiring substrate 10 has an elongated rectangular shape.

Each of the light-emitting devices 11 is a face-up type LED which is formed from a Group III nitride semiconductor and which emits blue light. A plurality of light-emitting devices 11 are provided on the wiring substrate 10 so as to align on an imaginary straight line along a longitudinal direction of the wiring substrate 10. The wiring pattern of the wiring substrate 10 is connected to the n-electrode and p-electrode (not illustrated) of each light-emitting device 11 by means of bonding wires (not illustrated).

In Embodiment 1, each light-emitting device 11 is of a face-up type and is wire-bonded to the wiring substrate 10. However, the light-emitting device 11 may be of a flip-chip type or may have a structure in which electrical conduction is achieved in a vertical direction.

The reflectors 12 provided on the wiring substrate 10 are separated from one another by grooves 15 such that each reflector corresponds to one light-emitting device 11. The reflectors 12 are formed from, for example, a resin material such as polyphthalamide, liquid crystal polymer, epoxy resin, modified epoxy resin, silicone resin, or modified silicone resin. Each reflector 12 is formed of two units 12a and 12b which face each other in a longitudinal direction of the linear light source apparatus 1 so as to sandwich one light-emitting device 11. The units 12a and 12b respectively have inclined surfaces 16a and 16b, which are located on the side of the light-emitting device 11 and inclined with respect to the main surface of the wiring substrate 10. The surfaces 16a and 16b are inclined such that the distance between them increases toward the top surface of the light-emitting device 11. The brightness of the linear light source apparatus 1 is increased and brightness unevenness is reduced by reflecting light from the light-emitting device 11 upward by means of the inclined surfaces 16a and 16b.

The sealing resin portion 13 is formed of a transparent silicone resin and seals the light-emitting device 11. The sealing resin portion 13 may be formed of, for example, an epoxy resin, a modified epoxy resin, or a modified silicone resin. The sealing resin portion 13 is provided for the purpose of protecting the light-emitting device 11 and bonding wires. The sealing resin portion 13 is formed so as not to be in contact with the reflector 12, and generally has a semicircular columnar shape. The sealing resin portion 13 is formed by potting a viscous silicone resin, and then curing the resin through thermal treatment. Since the silicone resin shrinks during this thermal treatment, stress is generated in the wiring substrate 10 so that the wiring substrate 10 warps so as to be convex in a downward direction from the surface on which the light-emitting device 11 is mounted toward the bottom surface of the substrate 10.

The sealing resin portion 13 is not necessarily transparent, and may be mixed with a fluorescent material or a reflective material. However, the sealing resin portion 13 is preferably transparent, from the viewpoint of suppressing color unevenness of light from the linear light source apparatus 1.

The fluorescent material sheet 14 is formed from glass mixed with a yellow fluorescent material which is excited by blue light and emits yellow fluorescence. The fluorescent material sheet 14 may be formed from, in place of glass, a resin material such as acrylic resin, epoxy resin, modified epoxy resin, silicone resin, or modified silicone resin. The fluorescent material sheet 14 is bonded to the respective reflectors 12 by means of, for example, an adhesive or a double-sided tape, and is located above all the light-emitting devices 11. The fluorescent material sheet 14 is not in contact with the sealing resin portion 13 formed on each light-emitting device 11. Therefore, an air layer 17 is provided in a space defined by the wiring substrate 10, the inclined surfaces 16a and 16b of the reflector 12, the sealing resin portion 13, and the fluorescent material sheet 14.

Operation of the linear light source apparatus 1 will next be described. When electric current flows through each of the light-emitting devices 11 via the wiring pattern of the wiring substrate 10, blue light is emitted radially from the light-emitting device 11. A portion of the emitted light transmits through the sealing resin portion 13 and the air layer 17 and reaches the fluorescent material sheet 14. Meanwhile, the remaining portion of the emitted light reaches the inclined surfaces 16a and 16b of the reflector 12 after having transmitted through the sealing resin portion 13 and the air layer 17, and is reflected by the incline surfaces 16a and 16b and reaches the fluorescent material sheet 14. Since the light-emitting devices 11 are aligned linearly, blue light in aligned form is emitted and diffused from the light-emitting devices 11. A portion of blue light reaching the fluorescent material sheet 14 transmits therethrough, and the remaining portion of blue light excites the yellow fluorescent material contained in the fluorescent material sheet 14, whereby yellow light is emitted. The linear light source apparatus 1 emits white light in aligned form by mixing of blue light transmitted through the fluorescent material sheet 14 with yellow light resulting from excitation of the yellow fluorescent material.

In the linear light source apparatus 1 according to Embodiment 1, the fluorescent material sheet 14 is provided so as to cover the reflectors 12. Therefore, stress applied to the wiring substrate 10, which is caused by thermal shrinkage of the sealing resin portion 13, can be relaxed, warpage of the linear light source apparatus 1 can be prevented, and color unevenness can be suppressed in light emitted from the linear light source apparatus 1. From this viewpoint, the rigidity of the fluorescent material sheet 14 is preferably greater than that of the wiring substrate 10. In such a case, warpage of the linear light source apparatus 1 can be further suppressed. The rigidity of the wiring substrate 10 or the fluorescent material sheet 14 is determined by the thickness thereof or the elastic modulus of the material thereof. Therefore, the rigidity of the fluorescent material sheet 14 can be adjusted to be greater than that of the wiring substrate 10 by controlling such a factor.

The sealing resin portion 13 is neither in contact with the reflector 12 nor in contact with the fluorescent material sheet 14. Therefore, the amount of the sealing resin portion 13 can be reduced as compared with conventional cases. In addition, since stress caused by thermal shrinkage of the sealing resin portion 13 can be reduced, warpage of the linear light source apparatus can be further suppressed. Also, since the fluorescent material sheet 14, which is provided above the light-emitting device 11, is not in contact with the sealing resin portion 13, by the intervention of the air layer 17, when a surface light source apparatus is produced by combining the linear light source apparatus 1 according to Embodiment 1 with a light guide plate, heat is less likely to be conducted to the light guide plate, and thus the light guide plate can be prevented from being degraded.

### Embodiment 2

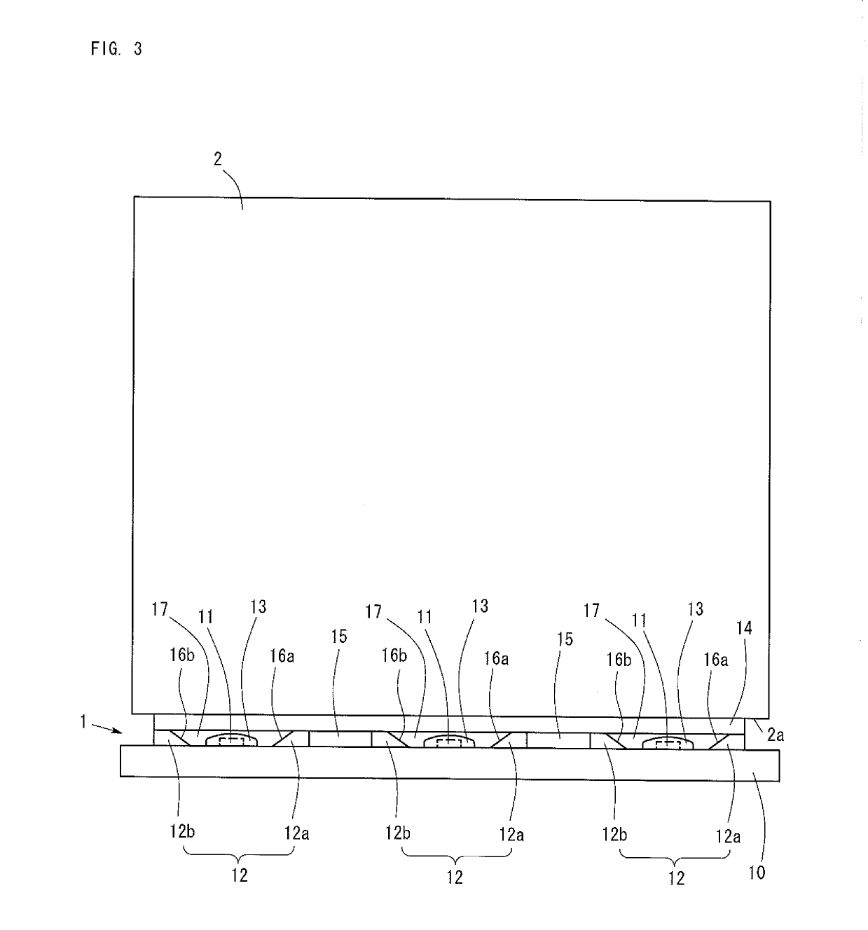

FIG. 3 shows the configuration of a surface light source apparatus according to Embodiment 2. The surface light source apparatus according to Embodiment 2 includes a rectangular light guide plate 2, and the linear light source apparatus 1 according to Embodiment 1 provided on a side surface of the light guide plate 2. The linear light source apparatus 1 and the light guide plate 2 are fixed by means of a frame (not illustrated) such that the side surface 2a of the light guide plate 2 is in contact with the fluorescent material sheet 14 of the linear light source apparatus 1. The fluorescent material sheet 14 of the linear light source apparatus 1 is formed from a material having a refractive index equal to or lower than that of the light guide plate 2. The light guide plate 2 may be formed from, for example, an acrylic resin or a polycarbonate resin.

Since the surface light source apparatus according to Embodiment 2 employs the linear light source apparatus 1 according to Embodiment 1 in which warpage is suppressed, the performance of light incidence to the light guide plate 2 can be increased, and surface emission of high brightness can be achieved. Also, since, in the linear light source apparatus 1 according to Embodiment 1, the air layer 17 is provided between the sealing resin portion 13 and the fluorescent material sheet 14, heat generated from the light-emitting device 11 is less likely to be conducted to the light guide plate 2, and thus thermal degradation of the light guide plate 2 can be suppressed. In addition, since the fluorescent material sheet 14 has a refractive index lower than that of the light guide plate 2, the performance of light incidence from the fluorescent material sheet 14 to the light guide plate 2 can be increased, and surface emission of higher brightness can be achieved.

The linear light source apparatus 1 according to Embodiment 1 is configured so as to emit white light by employing a blue light LED as the light-emitting device 11, and incorporating a yellow fluorescent material into the fluorescent material sheet 14. However, the color of light emitted from the light-emitting device 11 and the color of light emitted from the fluorescent material are not limited to the aforementioned examples, and light of any color from the linear light source apparatus may be achieved by combining emission of any color with fluorescence of any color. For example, the linear light source apparatus 1 may be configured so as to emit white light by employing an ultraviolet LED as the light-emitting device, and incorporating three types of fluorescent materials (i.e., a red fluorescent material, a green fluorescent material, and a blue fluorescent material) into the fluorescent material sheet 14.

The linear light source apparatus of the present invention can be combined with a light guide plate to produce a surface light source apparatus, and the surface light source apparatus can be employed as a backlight source of a small-sized liquid crystal display panel of, for example, a cellular phone or a digital camera.

What is claimed is:

1. A linear light source apparatus comprising:
a rectangular wiring substrate having thereon a wiring pattern;
a plurality of light-emitting devices which are provided on the wiring substrate so as to align on an imaginary straight line along a longitudinal direction of the wiring substrate, and which are connected to the wiring pattern of the wiring substrate;
reflectors each having inclined surfaces on the two longitudinal sides of each light-emitting device, and which are provided separately from one another such that each reflector corresponds to one light-emitting device;
a sealing resin portion which seals each light-emitting device; and
a fluorescent material sheet provided above all the light-emitting devices so as to cover and to be in contact with the reflectors;
wherein the fluorescent material sheet is not in contact with the sealing resin portion above each light-emitting device, by the intervention of an air layer.

2. A linear light source apparatus according to claim 1, wherein the fluorescent material sheet has rigidity greater than rigidity of the wiring substrate.

3. A linear light source apparatus according to claim 1, wherein the sealing resin portion is not in contact with the reflectors.

4. A linear light source apparatus according to claim 2, wherein the sealing resin portion is not in contact with the reflectors.

5. A linear light source apparatus according to claim 1, wherein the sealing resin portion is formed of a transparent resin.

6. A linear light source apparatus according to claim 2, wherein the sealing resin portion is formed of a transparent resin.

7. A linear light source apparatus according to claim 3, wherein the sealing resin portion is formed of a transparent resin.

8. A linear light source apparatus according to claim 1, wherein the fluorescent material sheet is made of at least one selected from a group consisting of glass, an acrylic resin, an epoxy resin, a modified epoxy resin, a silicone resin, and a modified silicone resin, each of which being mixed with a fluorescent material.

9. A linear light source apparatus according to claim 2, wherein the fluorescent material sheet is made of at least one selected from a group consisting of glass, an acrylic resin, an epoxy resin, a modified epoxy resin, a silicone resin, and a modified silicone resin, each of which being mixed with a fluorescent material.

10. A linear light source apparatus according to claim 3, wherein the fluorescent material sheet is made of at least one selected from a group consisting of glass, an acrylic resin, an epoxy resin, a modified epoxy resin, a silicone resin, and a modified silicone resin, each of which being mixed with a fluorescent material.

11. A linear light source apparatus according to claim 5, wherein the fluorescent material sheet is made of at least one selected from a group consisting of glass, an acrylic resin, an epoxy resin, a modified epoxy resin, a silicone resin, and a modified silicone resin, each of which being mixed with a fluorescent material.

12. A surface light source apparatus comprising:
a light guide plate, and
the linear light source apparatus as recited in claim 1,
wherein the linear light source apparatus is provided such that an emission surface thereof faces a side surface of the light guide plate, and the linear light source apparatus is disposed such that the fluorescent material sheet thereof is in contact with the side surface of the light guide plate, and the fluorescent material sheet has a refractive index equal to or lower than a refractive index of the light guide plate.

13. A surface light source apparatus comprising:
a light guide plate, and
the linear light source apparatus as recited in claim 2,
wherein the linear light source apparatus is provided such that an emission surface thereof faces a side surface of the light guide plate, and the linear light source apparatus is disposed such that the fluorescent material sheet thereof is in contact with the side surface of the light guide plate, and the fluorescent material sheet has a refractive index equal to or lower than a refractive index of the light guide plate.

14. A surface light source apparatus comprising:
a light guide plate, and
the linear light source apparatus as recited in claim 3,
wherein the linear light source apparatus is provided such that an emission surface thereof faces a side surface of the light guide plate, and the linear light source apparatus is disposed such that the fluorescent material sheet thereof is in contact with the side surface of the light guide plate, and the fluorescent material sheet has a refractive index equal to or lower than a refractive index of the light guide plate.

15. A surface light source apparatus comprising:
a light guide plate, and
the linear light source apparatus as recited in claim 5,
wherein the linear light source apparatus is provided such that an emission surface thereof faces a side surface of the light guide plate, and the linear light source apparatus is disposed such that the fluorescent material sheet thereof is in contact with the side surface of the light guide plate, and the fluorescent material sheet has a refractive index equal to or lower than a refractive index of the light guide plate.

16. A surface light source apparatus comprising:
a light guide plate, and
the linear light source apparatus as recited in claim 8,
wherein the linear light source apparatus is provided such that an emission surface thereof faces a side surface of the light guide plate, and the linear light source apparatus is disposed such that the fluorescent material sheet thereof is in contact with the side surface of the light guide plate, and the fluorescent material sheet has a refractive index equal to or lower than a refractive index of the light guide plate.
